(19) United States
(12) Patent Application Publication
(10) Pub. No.: US 2015/0228254 A1
(43) Pub. Date: Aug. 13, 2015

(54) Systems and Methods for Generating, Storing, and Displaying Anatomical Maps

(71) Applicant: St. Jude Medical, Cardiology Division, Inc., St. Paul, MN (US)

(72) Inventor: Eric Steven Olson, Maplewood, MN (US)

(21) Appl. No.: 14/611,597

(22) Filed: Feb. 2, 2015

Related U.S. Application Data
(60) Provisional application No. 61/936,954, filed on Feb. 7, 2014.

(51) Int. Cl. G09G 5/377; G06T 11/00

(52) U.S. Cl. CPC G09G 5/377; G06T 11/00; G09G 2340/12; G09G 2340/10

(57) ABSTRACT

A method of generating an anatomical map includes acquiring geometry information and biological information for an anatomical region. The geometry and biological information are associated with each other, for example by associating measured biological attributes with the anatomical locations at which they were measured. A graphical representation of the anatomical region, including a map of at least two biological attributes, can then be superimposed upon a geometric model of the anatomical region. The map can be a blended map and/or can utilize glyphs to represent the displayed biological attributes. The data used to generate the maps can also be stored in a data file.

### CROSS-REFERENCE TO RELATED APPLICATIONS

This application claims the benefit of U.S. provisional application No. 61/936,954, filed 7 Feb. 2014, which is hereby incorporated by reference as though fully set forth herein.

### BACKGROUND

The instant disclosure relates to anatomical mapping, such as may be performed in cardiac diagnostic and therapeutic procedures. In particular, the instant disclosure relates to systems, apparatuses, and methods for storing data useful in the creation of anatomical maps (e.g., cardiac electrophysiology maps) and then using such data to display such maps.

Anatomical mapping, such as cardiac electrophysiological mapping, is a part of numerous diagnostic and therapeutic procedures. As the complexity of such procedures increases, however, the anatomical maps utilized must increase in quality and in density. Indeed, such maps must be able to represent, in a manner readily comprehensible to the practitioner, a tremendous amount of data and a substantial number of biological attributes.

### BRIEF SUMMARY

Disclosed herein is a method of generating an anatomical map that includes: acquiring geometry information pertaining to an anatomical region, the geometry information including position information for a plurality of points in the anatomical region; acquiring biological information pertaining to the anatomical region, the biological information including a plurality of biological attributes of the anatomical region; associating the geometry information with the biological information; and displaying a graphical representation of the anatomical region including a map of at least two biological attributes of the anatomical region superimposed upon a geometric model of the anatomical region.

According to one aspect of the instant disclosure, the step of displaying a graphical representation of the anatomical region includes: assigning a first transparency to a first map of a first biological attribute of the anatomical region; assigning a second transparency to a second map of a second biological attribute of the anatomical region; blending the first map and the second map according to their respective transparencies into a blended map; and superimposing the blended map upon the geometric model of the anatomical region.

According to another aspect of the instant disclosure, the step of displaying a graphical representation of the anatomical region comprises: superimposing a first map of a first biological attribute of the anatomical region upon a first portion of the geometric model of the anatomical region; and superimposing a second map of a second biological attribute of the anatomical region upon a second portion of the geometric model of the anatomical region, wherein the first portion of the geometric model of the anatomical region and the second portion of the geometric model of the anatomical region are non-overlapping.

In yet another aspect, the step of displaying a graphical representation of the anatomical region comprises: establishing a glyph convention, wherein a glyph is defined by a plurality of glyph attributes, and wherein each glyph attribute is associated with a biological attribute of the anatomical region; and superimposing a plurality of glyphs upon the geometric model of the anatomical region, wherein at least two glyph attributes of the plurality of glyphs are representative of at least two biological attributes of the anatomical region.

Glyph attributes can include, without limitation: glyph shape; glyph line weight; glyph line style; glyph line color; glyph fill color; glyph fill transparency; glyph fill pattern; glyph size; glyph orientation; glyph text; glyph diameter; glyph radius of curvature; and glyph orientation. Biological attributes can include, without limitation: scar level; lateness attribute; voltage level; activation time; mechanical strain; electrogram frequency; electrogram fractionation; cycle length; fiber orientation; tissue thickness; fat content; local impedance; electrogram power; and statistical variability of any of the foregoing.

It is contemplated that either or both of the geometry information and the biological information can be time-varying. According to certain aspects, therefore, the step of displaying a graphical representation of the anatomical region includes superimposing a time-varying map of at least two biological attributes of the anatomical region upon a time-varying geometric model of the anatomical region, wherein the time-varying map of at least two biological attributes and the time-varying geometric model are synchronized time-wise.

Also disclosed herein is a method of generating an anatomical map that includes: acquiring a first plurality of measurements of a first biological attribute from within an anatomical region; acquiring a second plurality of measurements of a second biological attribute from within the anatomical region; designating a first glyph attribute to represent the first biological attribute; designating a second glyph attribute to represent the second biological attribute; displaying a geometric model of the anatomical region; superimposing a plurality of glyphs on the geometric model of the anatomical region, wherein the first glyph attribute of each glyph of the plurality of glyphs corresponds to a measurement of the first biological attribute at a corresponding location within the anatomical region, and the second glyph attribute of each glyph of the plurality of glyphs corresponds to a measurement of the second biological attribute at the corresponding location within the anatomical region.

The anatomical region can include a portion of a heart, and the geometric model of the anatomical region can be created from location data collected using a cardiac mapping and visualization system. Alternatively, or additionally, the geometric model of the anatomical region can be created from location data collected using at least one of an MRI system and a CT system.

In embodiments, the method also includes: acquiring a third plurality of measurements of a third biological attribute from within the anatomical region; designating a third glyph attribute to represent the third biological attribute; and modifying the plurality of glyphs superimposed on the geometric model of the anatomical region such that the third glyph attribute of each glyph of the plurality of glyphs corresponds to a measurement of the third biological attribute at the corresponding location within the anatomical region.

It is contemplated that the method can also include storing a data file including the first plurality of measurements of the first biological attribute and the second plurality of measurements of the second biological attribute. The data file can store the first plurality of measurements of the first biological attribute and the second plurality of measurements of the second biological attribute according to locations within the anatomical region at which they were measured.

In still another aspect of the disclosure, a system for generating an anatomical map includes: a geometry information processor that acquires geometry information pertaining to an anatomical region, the geometry information including position information for a plurality of points in the anatomical region; a biological information processor that acquires biological information pertaining to the anatomical region, the biological information including a plurality of biological attributes of the anatomical region; a mapping processor that associates the geometry information with the biological information and that displays a graphical representation of the anatomical region, the graphical representation including a map of at least two biological attributes of the anatomical region superimposed upon a geometric model of the anatomical region.

The system can also include an interface processor that establishes a graphical user interface, wherein the graphical user interface includes user controls to establish a glyph convention, wherein a glyph is defined by a plurality of glyph attributes, and wherein each glyph attribute is associated with a biological attribute of the anatomical region. The user controls can include, for example, a drag and drop interface.

In embodiments, the system also includes a storage medium that stores a data file including a plurality of records, wherein each record includes the associated biological information and geometry information of the mapping processor.

The foregoing and other aspects, features, details, utilities, and advantages of the present invention will be apparent from reading the following description and claims, and from reviewing the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of an electrophysiology system, such as may be used in an electrophysiology study.

FIG. 2 depicts an exemplary catheter used in an electrophysiology study.

FIG. 3 is a flowchart of representative steps that can be carried out in creating an anatomical map.

FIG. 4 is a representative data structure for storing geometry and biological information from which anatomical maps can be generated.

FIGS. 5a-5d depict graphical user interfaces usable to create anatomical maps in connection with the teachings herein.

FIG. 6 illustrates an anatomical map according to one aspect disclosed herein.

FIG. 7 illustrates an anatomical map according to another aspect disclosed herein.

FIG. 8 illustrates an anatomical map according to still another aspect disclosed herein.

### DETAILED DESCRIPTION

The present disclosure relates to the collection and storage of data used to create anatomical maps and to the display of anatomical maps from the data so collected and stored, and provides methods, apparatuses, and systems for the storage and display of anatomical maps. As used herein, the term “anatomical map” refers to a graphical representation of an anatomical region that includes both a geometric model of the anatomical region and biological information of the anatomical region. For example, the biological information can be superimposed upon the geometric model. As used herein, the term “superimposed” means that the biological information is displayed over the geometric model and can, in some embodiments, be incorporated into the geometric model. In other embodiments, the biological information is not part of the geometric model itself, but rather “hovers” as an overlay upon the geometric model.

Electrophysiology maps, such as those that can be created using system 8 described below, are one type of anatomical map. Electrophysiology maps include, without limitation, maps of local activation time (LAT), maps of complex fractionated electrogram (CFE) information, maps of local abnormal ventricular activities (LAVA), and the like.

For purposes of illustration, several exemplary embodiments will be described in detail herein in the context of a cardiac electrophysiology procedure, including the creation of cardiac electrophysiology maps. It is contemplated, however, that the methods, apparatuses, and systems described herein can be utilized in other contexts, including, without limitation, the creation of scar maps, streamline maps, and cardiac mechanical strain maps.

Electrophysiology maps are generally created from a plurality of electrophysiology data points, each of which includes both electrophysiology data (e.g., endocardial and/or epicardial electrograms (“EGMs”)) and location data (e.g., information regarding the location of the apparatus (e.g., catheter and/or catheter-mounted electrodes) collecting the electrophysiology data), allowing the electrophysiology information to be associated with a particular location in space (that is, allowing the electrophysiology information to be interpreted as indicative of electrical activity at a point on the patient's heart). Insofar as the ordinarily skilled artisan will be familiar with various modalities for the acquisition and processing of electrophysiology data points (including, for example, both contact and non-contact electrophysiological mapping), as well as with various techniques that can be used to generate a graphical representation from the plurality of electrophysiology data points, these aspects will only be described herein to the extent necessary to understand the present disclosure.

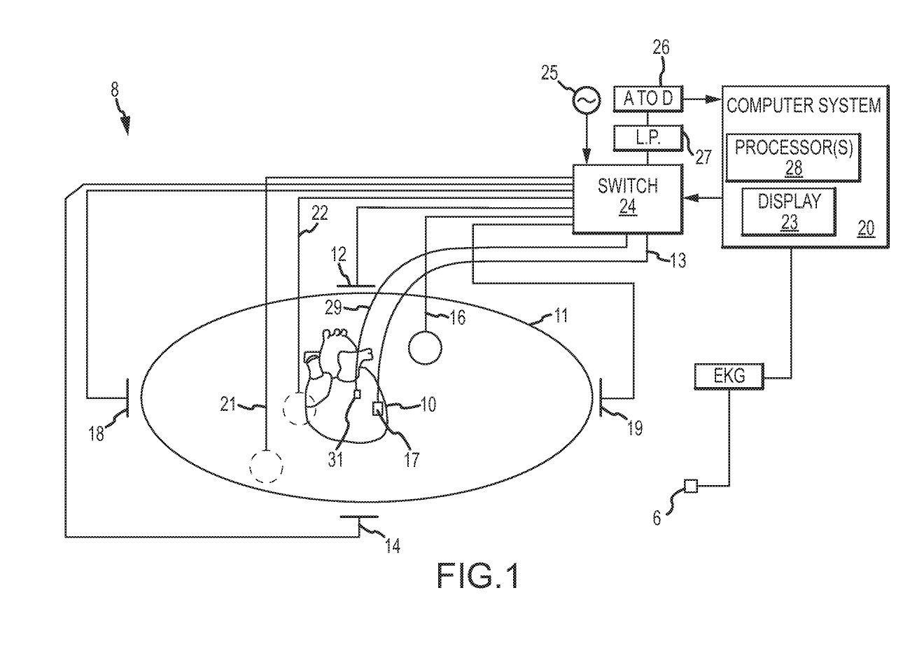

FIG. 1 shows a schematic diagram of an electrophysiology system 8 for conducting cardiac electrophysiology studies by navigating a cardiac catheter and measuring electrical activity occurring in a heart 10 of a patient 11 and three-dimensionally mapping the electrical activity and/or information related to or representative of the measured electrical activity. System 8 can be used, for example, to create an anatomical model of the patient's heart 10 using one or more electrodes. System 8 can also be used to measure electrophysiology data at a plurality of points along a cardiac surface and store the measured data in association with location information for each measurement point at which the electrophysiology data was measured, for example to create a diagnostic data map of the patient's heart 10.

As one of ordinary skill in the art will recognize, and as will be further described below, system 8 can determine the location, and in some aspects the orientation, of objects, typically within a three-dimensional space, and express those locations as position information determined relative to at least one reference.

For simplicity of illustration, the patient 11 is depicted schematically as an oval. In the embodiment shown in FIG. 1, three sets of surface electrodes (e.g., patch electrodes) are shown applied to a surface of the patient 11, defining three generally orthogonal axes, referred to herein as an x-axis, a y-axis, and a z-axis. In other embodiments the electrodes could be positioned in other arrangements, such as, for example multiple electrodes on a particular body surface. As a further alternative, the electrodes do not need to be on the body surface, but could be positioned internally to the body or on an external frame.

In FIG. 1, the x-axis surface electrodes 12, 14 are applied to the patient along a first axis, such as on the lateral sides of the thorax region of the patient (e.g., applied to the patient's skin underneath each arm) and may be referred to as the Left and Right electrodes. The y-axis electrodes 18, 19 are applied to the patient along the sternum and spine of the patient in the thorax region, and may be referred to as the Chest and Back electrodes. The z-axis electrodes 16, 22 are applied along a third axis generally orthogonal to both the x-axis and the y-axis, such as along the inner thigh and neck regions of the patient, and may be referred to as the Left Leg and Neck electrodes. The heart 10 lies between these pairs of surface electrodes 12/14, 18/19, and 16/22.

An additional surface reference electrode (e.g., a “belly patch”) 21 provides a reference and/or ground electrode for the system 8. The belly patch electrode 21 may be an alternative to a fixed intra-cardiac electrode 31, described in further detail below. It should also be appreciated that, in addition, the patient 11 may have most or all of the conventional surface electrocardiogram (“ECG” or “EKG”) system leads in place. In certain embodiments, for example, a standard set of 12 ECG leads may be utilized for sensing electrocardiograms of the patient's heart 10. This ECG information is available to the system 8 (e.g., it can be provided as input to computer system 20). Insofar as ECG leads are well understood, and for the sake of clarity in the figures, only one lead 6 and its connection to computer system 20 is illustrated in FIG. 1.

A representative catheter 13 having at least one electrode 17 (e.g., a distal electrode) is also depicted in schematic fashion. This representative catheter electrode 17 can be referred to as a “measurement electrode.” Typically, multiple electrodes on catheter 13, or on multiple such catheters, will be used. In one embodiment, for example, system 8 may utilize sixty-four electrodes on twelve catheters disposed within the heart and/or vasculature of the patient. Of course, this embodiment is merely exemplary, and any number of electrodes and catheters may be used. Indeed, in some embodiments, a high density mapping catheter, such as the EnSite™ Array™ non-contact mapping catheter of St. Jude Medical, Inc., can be utilized.

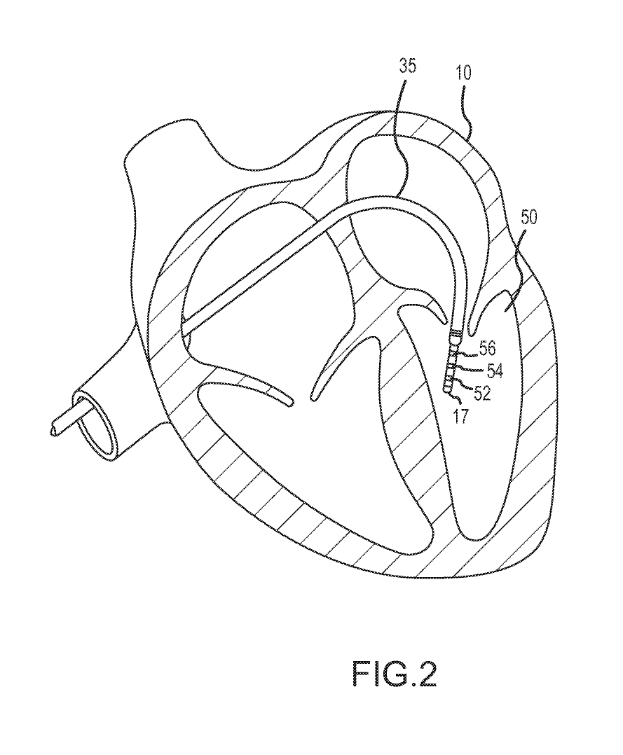

Likewise, it should be understood that catheter 13 (or multiple such catheters) are typically introduced into the heart and/or vasculature of the patient via one or more introducers and using familiar procedures. For purposes of this disclosure, a segment of an exemplary catheter 13 is shown in FIG. 2. In FIG. 2, catheter 13 extends into the left ventricle 50 of the patient's heart 10 through a transseptal sheath 35. The use of a transseptal approach to the left ventricle is well known and will be familiar to those of ordinary skill in the art, and need not be further described herein. Of course, catheter 13 can also be introduced into the heart 10 in any other suitable manner.

Catheter 13 includes electrode 17 on its distal tip, as well as a plurality of additional measurement electrodes 52, 54, 56 spaced along its length in the illustrated embodiment. Typically, the spacing between adjacent electrodes will be known, though it should be understood that the electrodes may not be evenly spaced along catheter 13 or of equal size to each other. Since each of these electrodes 17, 52, 54, 56 lies within the patient, location data may be collected simultaneously for each of the electrodes by system 8.

Returning now to FIG. 1, in some embodiments, a fixed reference electrode 31 (e.g., attached to a wall of the heart 10) is shown on a second catheter 29. For calibration purposes, this electrode 31 may be stationary (e.g., attached to or near the wall of the heart) or disposed in a fixed spatial relationship with the measurement electrodes (e.g., electrodes 17, 52, 54, 56), and thus may be referred to as a “navigational reference” or “local reference.” The fixed reference electrode 31 may be used in addition or alternatively to the surface reference electrode 21 described above. In many instances, a coronary sinus electrode or other fixed electrode in the heart 10 can be used as a reference for measuring voltages and displacements; that is, as described below, fixed reference electrode 31 may define the origin of a coordinate system.

Each surface electrode is coupled to a multiplex switch 24, and the pairs of surface electrodes are selected by software running on a computer 20, which couples the surface electrodes to a signal generator 25. Alternately, switch 24 may be eliminated and multiple (e.g., three) instances of signal generator 25 may be provided, one for each measurement axis (that is, each surface electrode pairing).

The computer 20, for example, may comprise a conventional general-purpose computer, a special-purpose computer, a distributed computer, or any other type of computer. The computer 20 may comprise one or more processors 28, such as a single central processing unit (CPU), or a plurality of processing units, commonly referred to as a parallel processing environment, which may execute instructions to practice the various aspects disclosed herein.

Generally, three nominally orthogonal electric fields are generated by a series of driven and sensed electric dipoles (e.g., surface electrode pairs 12/14, 18/19, and 16/22) in order to realize catheter navigation in a biological conductor. Alternatively, these orthogonal fields can be decomposed and any pairs of surface electrodes can be driven as dipoles to provide effective electrode triangulation. Likewise, the electrodes 12, 14, 18, 19, 16, and 22 (or any other number of electrodes) could be positioned in any other effective arrangement for driving a current to or sensing a current from an electrode in the heart. For example, multiple electrodes could be placed on the back, sides, and/or belly of patient 11. For any desired axis, the potentials measured across the roving electrodes resulting from a predetermined set of drive (source-sink) configurations may be combined algebraically to yield the same effective potential as would be obtained by simply driving a uniform current along the orthogonal axes.

Thus, any two of the surface electrodes 12, 14, 16, 18, 19, 22 may be selected as a dipole source and drain with respect to a ground reference, such as belly patch 21, while the unexcited electrodes measure voltage with respect to the ground reference. The measurement electrodes 17, 52, 54, 56 placed in the heart 10 are exposed to the field from a current pulse and are measured with respect to ground, such as belly patch 21. In practice the catheters within the heart 10 may contain more or fewer electrodes than the four shown, and each electrode potential may be measured. As previously noted, at least one electrode may be fixed to the interior surface of the heart to form a fixed reference electrode 31, which is also measured with respect to ground, such as belly patch 21, and which may be defined as the origin of the coordinate system relative to which localization system 8 measures positions. Data sets from each of the surface electrodes, the internal electrodes, and the virtual electrodes may all be used to determine the location of the measurement electrodes 17, 52, 54, 56 within heart 10.

The measured voltages may be used by system 8 to determine the location in three-dimensional space of the electrodes inside the heart, such as measurement electrodes 17, 52, 54, 56, relative to a reference location, such as reference electrode 31. That is, the voltages measured at reference electrode 31 may be used to define the origin of a coordinate system, while the voltages measured at measurement electrodes 17, 52, 54, 56 may be used to express the location of measurement electrodes 17, 52, 54, 56 relative to the origin. In some embodiments, the coordinate system is a three-dimensional (x, y, z) Cartesian coordinate system, although other coordinate systems, such as polar, spherical, and cylindrical coordinate systems, are contemplated.

As should be clear from the foregoing discussion, the data used to determine the location of the electrode(s) within the heart is measured while the surface electrode pairs impress an electric field on the heart. The electrode data may also be used to create a respiration compensation value used to improve the raw location data for the electrode locations as described in U.S. Pat. No. 7,263,397, which is hereby incorporated herein by reference in its entirety. The electrode data may also be used to compensate for changes in the impedance of the body of the patient as described, for example, in U.S. Pat. No. 7,885,707, which is also incorporated herein by reference in its entirety.

In one representative embodiment, the system 8 first selects a set of surface electrodes and then drives them with current pulses. While the current pulses are being delivered, electrical activity, such as the voltages measured with at least one of the remaining surface electrodes and in vivo electrodes, is measured and stored. Compensation for artifacts, such as respiration and/or impedance shifting, may be performed as indicated above.

In some embodiments, system 8 is the EnSite™ Velocity™ cardiac mapping and visualization system of St. Jude Medical, Inc., which generates electrical fields as described above, or another such system that relies upon electrical fields. Other systems, however, may be used in connection with the present teachings, including for example, the CARTO navigation and location system of Biosense Webster, Inc. or the AURORA® system of Northern Digital Inc., both of which utilize magnetic fields rather than electrical fields. The localization and mapping systems described in the following patents (all of which are hereby incorporated by reference in their entireties) can also be used: U.S. Pat. Nos. 6,990,370; 6,978,168; 6,947,785; 6,939,309; 6,728,562; 6,640,119; 5,983,126; and 5,697,377.

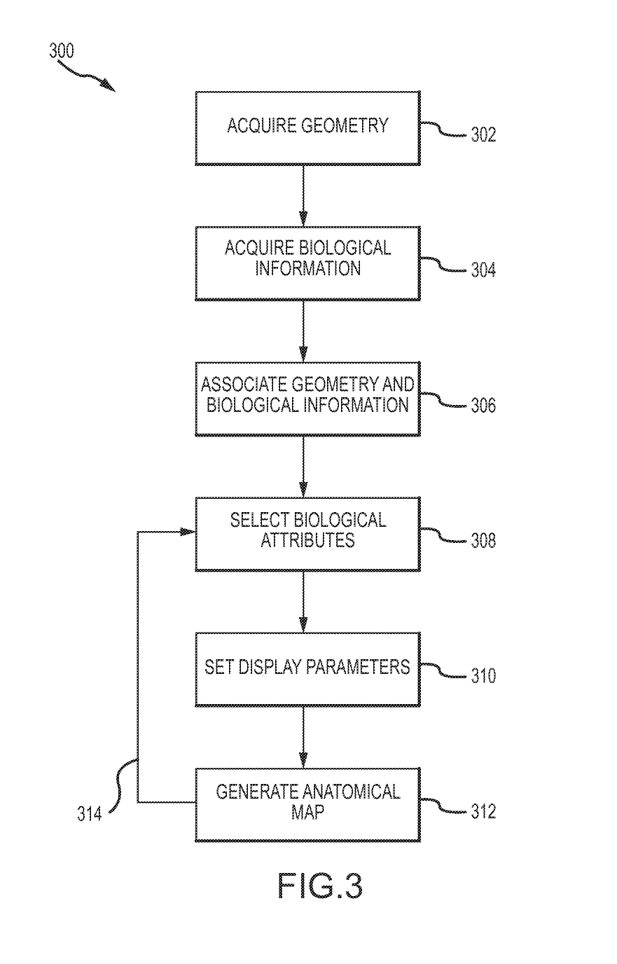

FIG. 3 is a flowchart 300 of representative steps that can be carried out to create an anatomical map. Advantageously, the anatomical maps disclosed herein depict multiple variables (e.g., multiple cardiac electrophysiological characteristics) by location (e.g., according to their position on the surface of the heart). In some embodiments, the flowchart may represent several exemplary steps that can be carried out by the computer 20 of FIG. 1 (e.g., by one or more processors 28) to generate an anatomical map. It should be understood that the representative steps described below can be either hardware- or software-implemented. For the sake of explanation, the term “signal processor” is used herein to describe both hardware- and software-based implementations of the teachings herein.

In block 302, geometry information pertaining to an anatomical region (e.g., a heart chamber) is acquired. The acquired geometry information includes position information (e.g., Cartesian coordinates) for a plurality of points in the anatomical region.

The geometry can be acquired in numerous ways, many of which will be familiar to the person of ordinary skill in the art. For example, in certain aspects, system 8 is used to gather a plurality of location points that define the geometry of the anatomical region; the plurality of location points can then be used to create a model of the anatomical region. In other aspects, an external imaging modality, such as magnetic resonance imaging (“MRI”), computed tomography (“CT”), positron emission tomography (“PET”), ultrasound imaging, single-photon emission computed tomography (“SPECT”), or the like is used. It is also contemplated that multiple geometries can be acquired from multiple imaging modalities. Where multiple geometries are acquired, they can be fused or registered to a common coordinate system, for example as disclosed in U.S. application Ser. No. 11/715,923, filed 9 Mar. 2007, and/or U.S. application Ser. No. 13/087,203, filed 14 Apr. 2011, both of which are hereby incorporated by reference in their entirety as though fully set forth herein).

Further, the geometry information can be time-varying. For example, cardiac geometry will vary over time with the beating of the heart. Thus, rather than acquiring a single geometry at a single point in time (e.g., max systole or max diastole), a plurality of time-varying geometries can be captured, such as by segmenting multiple phases from volumetric images captured by an MRI or CT system. As discussed in greater detail below, these time-varying geometries can be used to create an animated geometric model of the anatomical region.

In block 304, biological information pertaining to the anatomical region is acquired. The biological information includes a plurality of biological attributes of the anatomical region. Representative biological attributes are discussed in further detail below.

Just as there are numerous ways to acquire the geometry information in block 302, so too are there numerous ways to acquire the biological information in block 304. For example, system 8 (e.g., electrodes 17, 52, 54, and 56 on catheter 13) can be used to measure electrical activity on the surface of the patient's heart 10. Similarly, LGE-MRI (also referred to as DE-MRI) can be used to identify ischemic tissue, with the degree of enhancement indicative of the level of scar. Other information, such as strains and strain rates, can also be captured using MRI.

The biological information can also be time-varying. For example, strain rate will vary over time with the beating of the heart. Thus, rather than acquiring a single set of strain measurements corresponding to a single point in time, the strain rate can be measured over time, and, as discussed in further detail below, the time-varying strain rate can be used to create an animated strain rate map of the anatomical region.

Various biological attributes can be mapped using the methods and systems disclosed herein. For example, scar levels (e.g., ischemia), lateness attributes (e.g., late activity, or “Late-A” and/or late potential or “Late-P” attributes), voltage levels (e.g., peak-to-peak voltages), activation times (e.g., local activation time or “LAT”), mechanical strain, electrogram frequency, electrogram fractionation, cycle length, fiber orientation, and any other biological data of interest can all be collected in block 304. Biological attributes can also include non-quantitative attributes, such as the direction of a depolarization wavefront, and statistical variability in quantitative and non-quantitative attributes. For example, in one embodiment, three dimensional vector electrograms associated with the direction of a depolarization wavefront can be mapped, such as disclosed in International Publication No. WO 2012/092016, which is hereby incorporated by reference in its entirety as though fully set forth herein.

In block 306, the geometry information acquired in block 302 is associated with the biological information acquired in block 304. For example, electrophysiology measurements made by electrodes 17, 52, 54, 56 can be associated with the position of catheter 13 at the time the measurements were made. As another example, electrophysiology measurements can be associated with locations within a CT model after the CT model has been registered to the coordinate frame of system 8.

Other embodiments are also contemplated. For example, the biological information can include force, impedance, ultrasound data, and other biological data. Similarly, as described above, the geometry information can be acquired by MRI, PET, SPECT, ultrasound, or any other imaging modality. It should be understood that various combinations and permutations of the foregoing biological information and geometry information are within the scope of the present disclosure, and the teachings herein can be extended to any such combination or permutation.

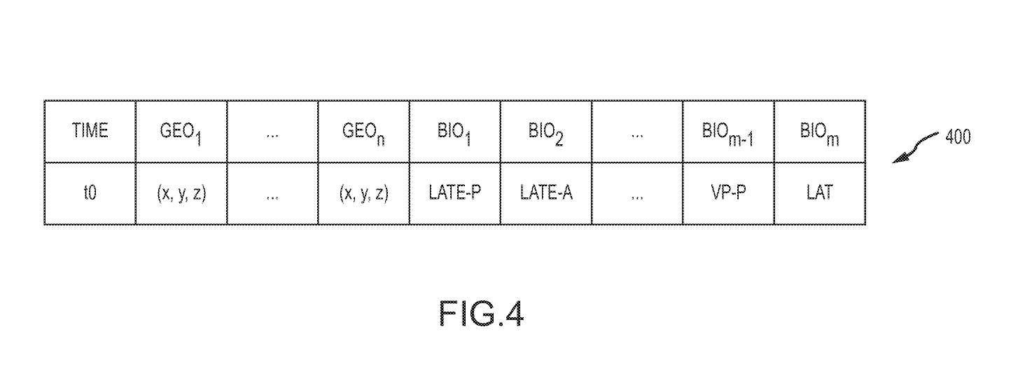

The associated geometry and biological information can then be stored, for example in the memory of computer system 20, for use in the creation (and manipulation) of anatomical maps. FIG. 4 is a representative data structure 400 for storing the associated geometry and biological information. As depicted in FIG. 4, the stored information includes an association of n geometries of an anatomical region and m biological attributes of the anatomical region. For example, GEO₁ can be the Cartesian coordinates of catheter 13 as measured by system 8, while GEOₙ can be the corresponding Cartesian coordinates in an externally derived CT or MRI image. BIO₁ through BIOₘ can be various biological attributes (e.g., Late-P, Late-A, Peak-to-Peak voltage, local activation time) measured at the coordinates GEO₁ through GEOₙ, measured near the coordinates GEO₁ through GEOₙ, extrapolated from other measured values to the coordinates GEO₁ through GEOₙ, or otherwise corresponding to the coordinates GEO₁ through GEOₙ. Time information (“TIME”) can also be included when the geometry information and/or biological information is time-varying. This information can be stored in any suitable file format. For example, the file format can include the capability to store multivariate biological data with geometrical information in an XML format.

In step 308, a user can select biological attributes to display in an anatomical map. Likewise, in step 310, the user can set various display parameters for the selected biological attributes.

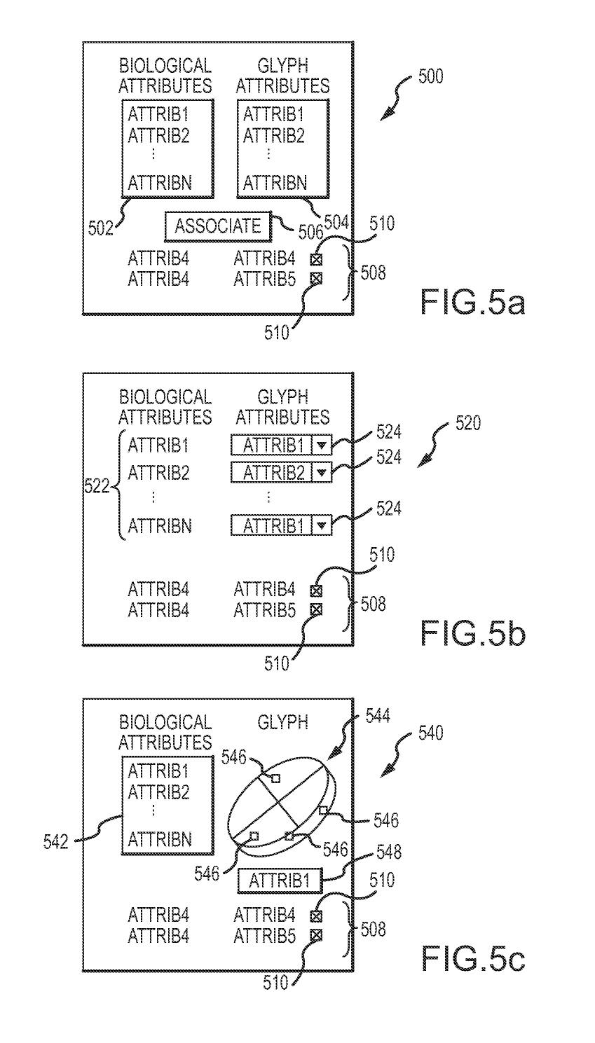

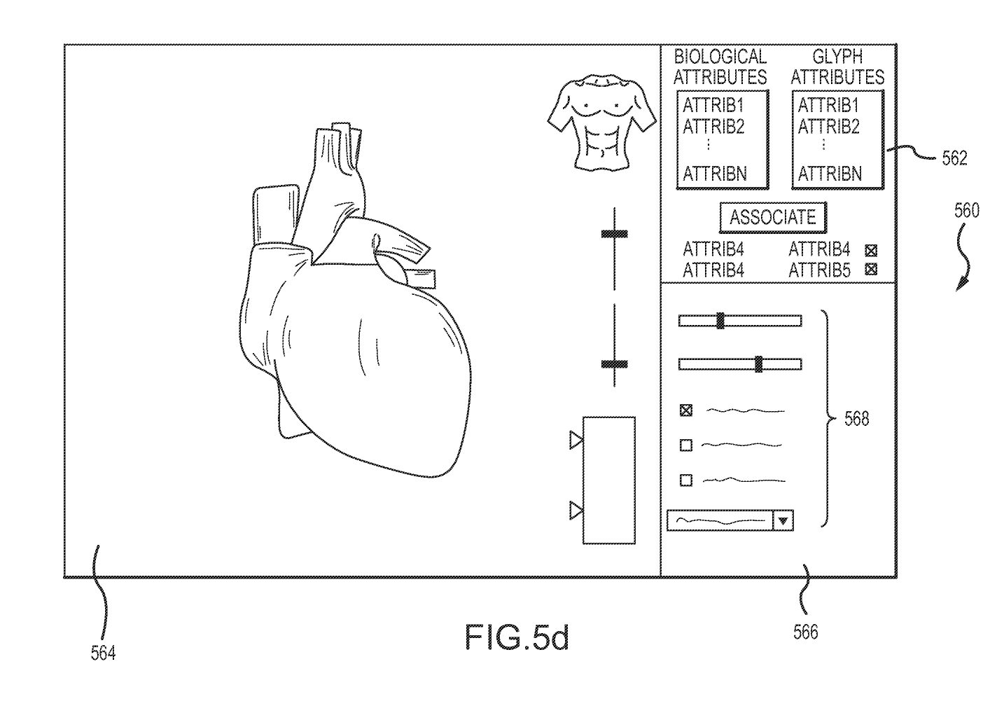

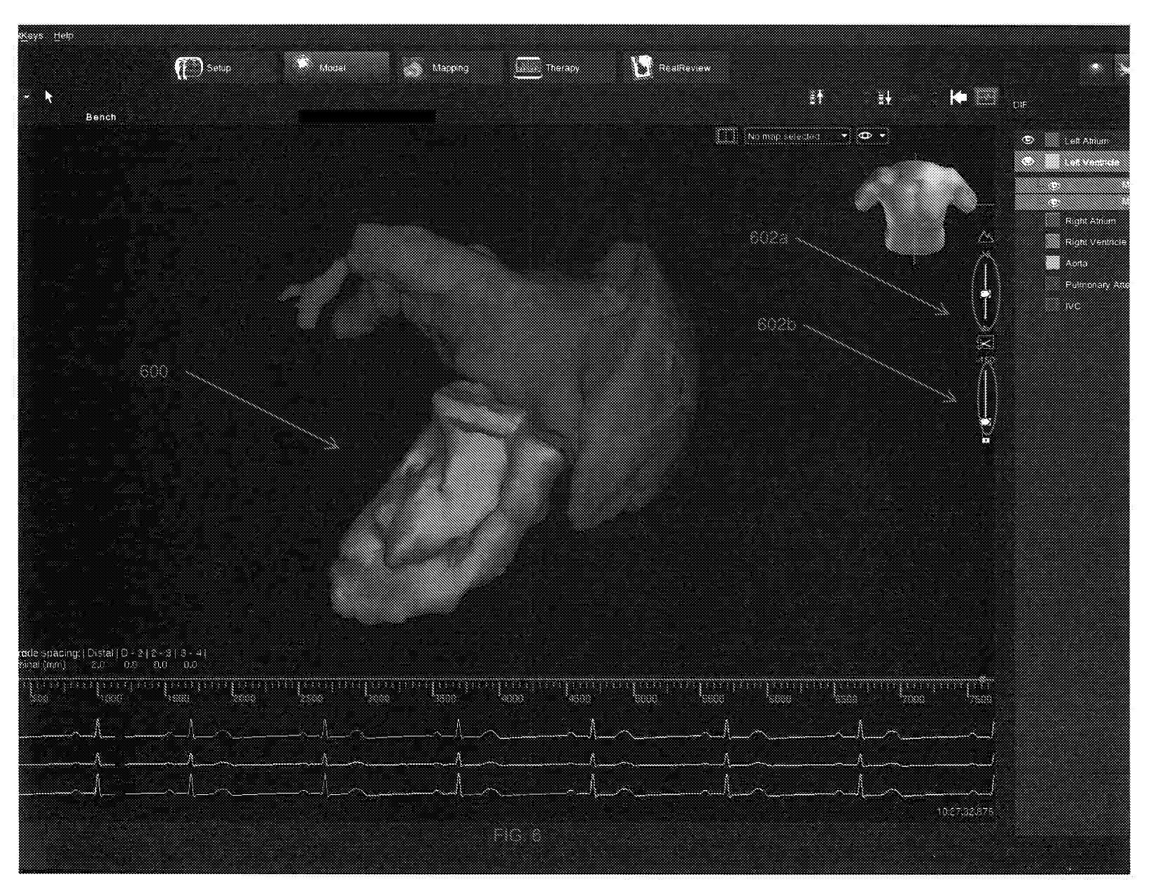

FIGS. 5a-5c are representative graphical user interfaces (“GUIs”) that provide user controls for the selection of biological attributes and the setting of display parameters for the selected biological attributes. For example, FIG. 5a depicts a set of user controls 500 that includes two listings: a listing of biological attributes 502 (identified for purposes of illustration as ATTRIB1, ATTRIB2, and so forth; various specific biological attributes are discussed throughout this disclosure) and a listing of display parameters, in this case glyph attributes 504 (generally identified as ATTRIB1, ATTRIB2, and so forth; various specific glyph attributes are discussed herein). The user can select (e.g., by mouse click) a biological attribute to display from listing 502 and can select (e.g., by mouse click) a glyph attribute from listing 504 to represent the selected biological attribute, and can associate the selected biological attribute with the selected glyph attribute by using the “associate” button 506. For the user's reference, a listing 508 of associations between biological and glyph attributes can also be provided. Likewise, delete buttons 510 can be provided to delete associations between biological attributes and glyph attributes that are no longer desired to be displayed. A drag and drop implementation, where a user drags a biological attribute from listing 502 and drops it on a glyph attribute to be associated in listing 504, is also contemplated.

FIG. 5b illustrates a set of user controls 520 that includes a listing of biological attributes 522, each with an associated drop down box 524 of glyph attributes. For each biological attribute in listing 522, the user can use the associated drop down box 524 to select an associated glyph attribute. User controls 520 can also incorporate listing 508 of associations and their respective delete buttons 510.

FIG. 5c illustrates a set of user controls 540 according to another aspect of the disclosure. In this embodiment, a listing of biological attributes 542 and a representative glyph 544 are provided. Glyph 544 includes hot spots 546 corresponding to its various attributes. The user can drag and drop a biological attribute from listing 542 onto a hot spot 546, which will associate the selected biological attribute with the glyph attribute corresponding to the hot spot. Help text 548, which can appear when a user hovers over a particular hot spot 546, can be provided to guide the user in associating biological attributes with glyph attributes by identifying the attribute associated with a particular hot spot. Listing 508 of associations can also be displayed, as can delete buttons 510.

It is contemplated that each glyph attribute will only be associated with a single biological attribute. That is, each glyph attribute will represent one, and only one, biological attribute. It is, however, contemplated that each biological attribute can be associated with multiple glyph attributes. For example, in FIGS. 5a through 5c, biological attribute ATTRIB4 is associated with both glyph attribute ATTRIB4 and glyph attribute ATTRIB5.

As shown in FIG. 5d, user controls (e.g., 500, 520, 540) can be provided as a pane 562 within an overall GUI 560, and can, for example, be included or incorporated in the GUI for electrophysiology system 8. Pane 564 of GUI 560 can include an anatomical map (e.g., anatomical map 800, discussed in detail below). Pane 566 of GUI 560 can include additional controls 568, including, without limitation, display controls for transparency/opacity, sliders to assign color or grayscale values, check boxes to display or hide various additional graphical elements (e.g., to show or hide a representation of catheter 13) on the anatomical map, and the like.

The anatomical map is generated in block 312. As discussed above, the anatomical map is a graphical representation of a geometric model of an anatomical region with biological information superimposed thereon. Thus, for example, the acquired geometry (or geometries) can be rendered graphically (e.g., using techniques that are familiar to those of ordinary skill in the art), and a map of the biological attributes selected in step 308 can be superimposed thereon.

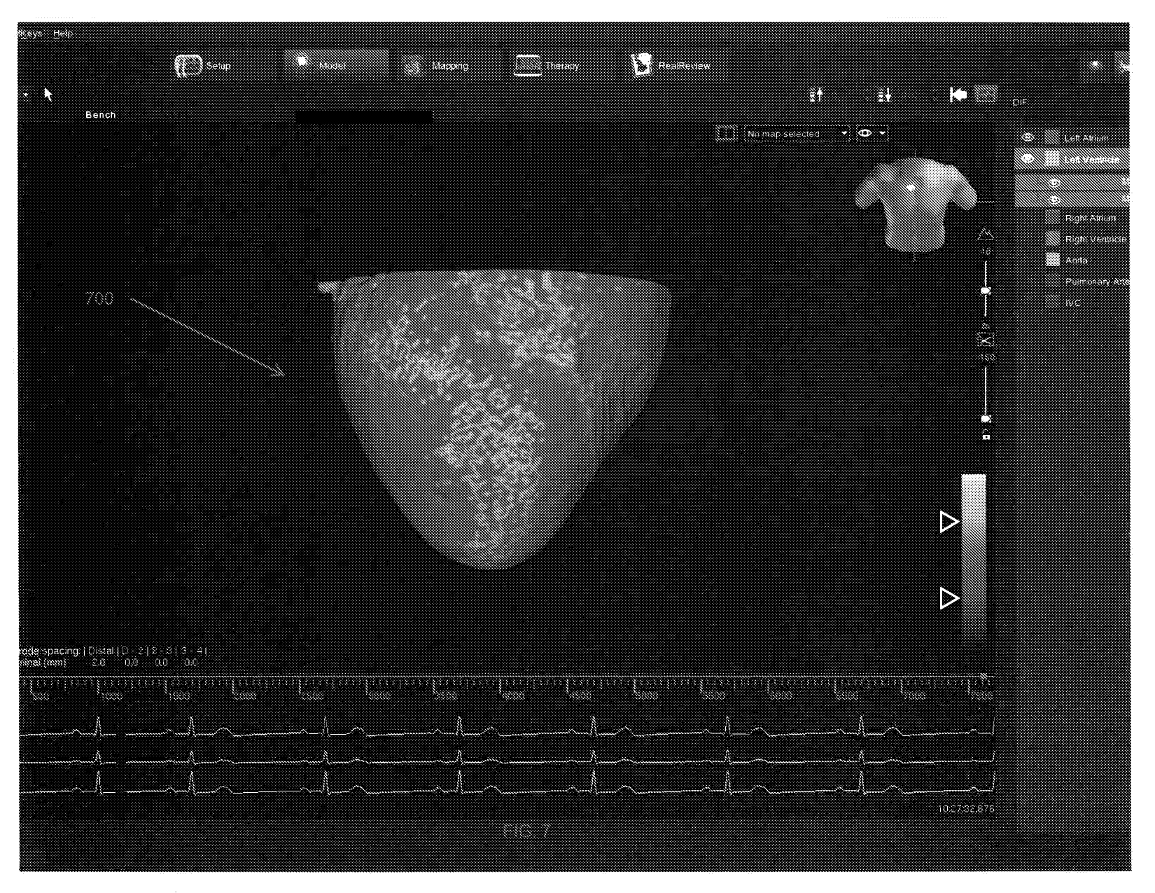

FIG. 6 illustrates an anatomical map 600 according to one aspect of the present disclosure. In particular, FIG. 6 depicts an anatomical map that that simultaneously displays two (or more) biological attributes by blending overlapping maps. According to the embodiment depicted in FIG. 6, a first map of a first biological attribute is assigned a first transparency value, while a second map of a second biological attribute is assigned a second transparency value. Respective transparency sliders 602a, 602b can be used to adjust the transparency assigned to each map. Where the first and second maps overlap, they are blended according to their respective transparency values, for example in the manner performed in 3D graphics toolkits such as OpenGL and/or DirectX. The result is a blended map that can be superimposed upon the displayed geometric model.

The term “blended map” can also be used to refer to an anatomical map that is a composite of multiple underlying biological attribute maps even if the displayed maps are defined in such a way that they do not overlap. It should be understood, however, that no “blending,” as that term is used in the computer graphics context, will occur in such maps because the underlying maps do not overlap.

FIG. 7 illustrates an anatomical map 700 according to another aspect of the present disclosure. In particular, FIG. 7 depicts a scalar valued color map.

The anatomical maps 600, 700 depicted in FIGS. 6 and 7 respectively can be used to good advantage when a relatively small number of biological attributes are to be depicted. For more complex anatomical maps that depict a larger number of biological attributes, “glyphs” can be used. A “glyph” is a graphical object, often in three dimensions, that is defined by a plurality of glyph attributes. Each glyph attribute can be associated with a biological attribute according to a preset glyph convention or according to user's selection and definition of a glyph convention (e.g., through the use of user controls 500, 520, 540). A plurality of glyphs can then be superimposed upon the geometric model.

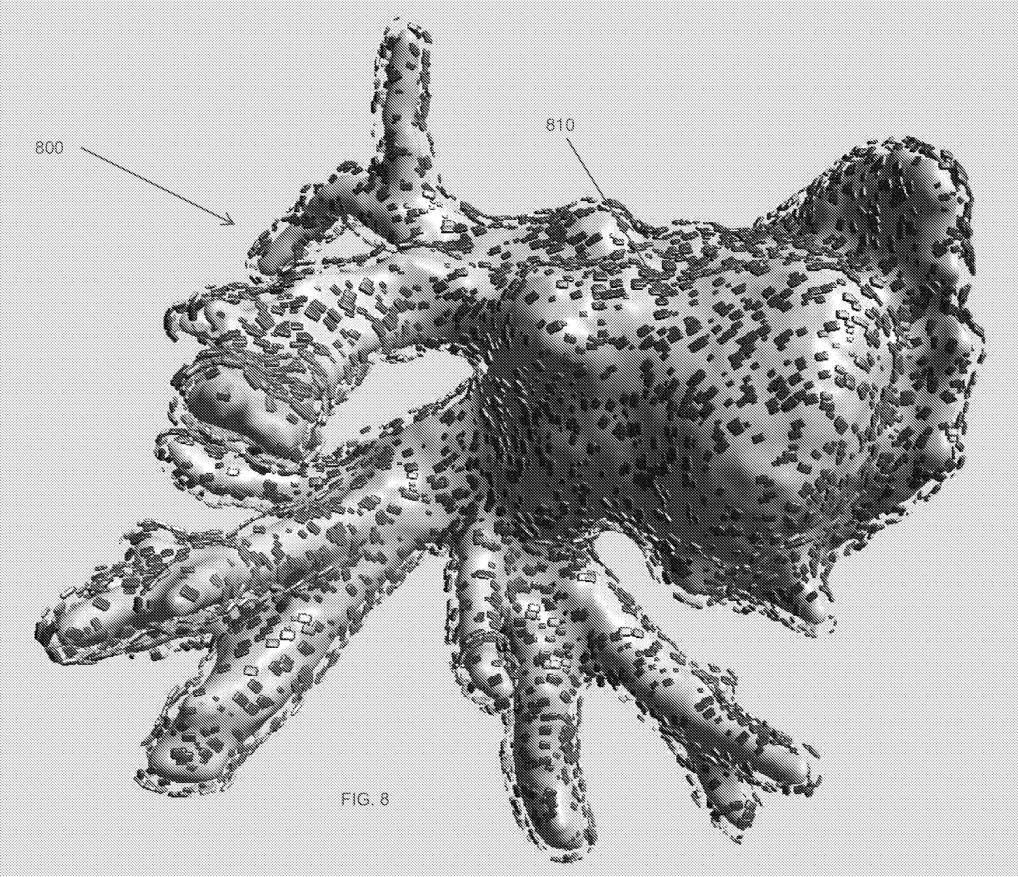

FIG. 8 depicts a representative anatomical map 800 including a plurality of superquadric tensor glyphs 810 thereon. Superquadric tensor glyphs are described in further detail in Gordon Kindlmann, Superquadric Tensor Glyphs, Joint EUROGRAPHICS—IEEE TCVG Symposium on Visualization (2004), which is hereby incorporated by reference as though fully set forth herein. Other glyphs, such as ellipsoidal glyphs, are within the scope of the instant disclosure as well.

Various glyph attributes can be used to represent biological attributes. These glyph attributes include, without limitation: glyph orientation; glyph major axis size (e.g., diameter on each major axis); glyph minor axis size (e.g., diameter on each minor axis); glyph color; glyph shape; glyph line weight; glyph line style; glyph line color; glyph fill color; glyph fill transparency; glyph fill pattern; glyph text; and glyph radius of curvature in each dimension.

Any of the anatomical maps can be animated using time-varying geometry and/or biological information. For example, a sequence of ten geometric models, each based on geometry information collected at a different point in a heartbeat, can be used to create an animation of the beating heart. Similarly, a sequence of ten different sets of biological attribute measurements, each collected at a different point in a heartbeat, can be used to create an animation of how the biological attributes vary over time. The animations can be synchronized in time, for example by using EKG/ECG and/or EGM information collected by system 8. The animations can also be smoothed by interpolating geometry and/or biological attribute values between those acquired in steps 302 and/or 304, respectively.

FIG. 3 also shows a loop 314 back to step 308. That is, the practitioner can select new and/or different biological attributes to display and/or alter the display parameters in real time, which will generate new anatomical maps in later iterations of step 312.

The foregoing teachings can also be combined to achieve additional anatomical maps. For example, an anatomical map according to the teachings herein can include both blended maps that utilize color, greyscale, and/or transparency to display certain biological attributes (as in FIGS. 6 and 7), as well as glyphs to display additional biological attributes (as in FIG. 8).

Although several embodiments of this invention have been described above with a certain degree of particularity, those skilled in the art could make numerous alterations to the disclosed embodiments without departing from the spirit or scope of this invention.

For example, additional aspects, such as graphical primitives (e.g., lines and points), representations of medical devices (e.g., catheters), annotations (e.g., labels and markers), and signals (e.g., EKG/ECG signals, EGMs, and/or respiration signals) can be included in the data file along with the acquired geometry and biological information.

As another example, the teachings herein can be used to render “streamline maps” of myocardial fiber orientation. Fiber orientation can be informative for ablation therapies in the treatment of ventricular tachycardia (“VT”), where reentrant waves preferentially follow the path of fiber orientation. Glyphs are well suited to streamline maps.

As still another example, and as discussed briefly above, the biological attributes represented in an anatomical map according to the teachings herein can be not only quantitative and non-quantitative attributes, but also statistical variability in such attributes. For example, the depolarization wave front can have a different direction at a particular spot on the endocardium during different cardiac cycles. One glyph-represented biological attribute could thus be the average direction of the wave front, and another glyph-represented biological attribute could be variability in direction. An arrowhead glyph could be used to represent these attributes, and the aspect ratio of the arrowhead glyph could be used to represent a confidence value.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of generating an anatomical map, comprising:
acquiring geometry information pertaining to an anatomical region, the geometry information comprising position information for a plurality of points in the anatomical region;
acquiring biological information pertaining to the anatomical region, the biological information comprising a plurality of biological attributes of the anatomical region;
associating the geometry information with the biological information; and
displaying a graphical representation of the anatomical region including a map of at least two biological attributes of the anatomical region superimposed upon a geometric model of the anatomical region.

2. The method according to claim 1, wherein displaying a graphical representation of the anatomical region comprises:
assigning a first transparency to a first map of a first biological attribute of the anatomical region;
assigning a second transparency to a second map of a second biological attribute of the anatomical region;
blending the first map and the second map according to their respective transparencies into a blended map; and
superimposing the blended map upon the geometric model of the anatomical region.

3. The method according to claim 1, wherein displaying a graphical representation of the anatomical region comprises:
superimposing a first map of a first biological attribute of the anatomical region upon a first portion of the geometric model of the anatomical region; and
superimposing a second map of a second biological attribute of the anatomical region upon a second portion of the geometric model of the anatomical region,
wherein the first portion of the geometric model of the anatomical region and the second portion of the geometric model of the anatomical region are non-overlapping.

4. The method according to claim 1, wherein displaying a graphical representation of the anatomical region comprises:
establishing a glyph convention, wherein a glyph is defined by a plurality of glyph attributes, and wherein each glyph attribute is associated with a biological attribute of the anatomical region; and
superimposing a plurality of glyphs upon the geometric model of the anatomical region, wherein at least two glyph attributes of the plurality of glyphs are representative of at least two biological attributes of the anatomical region.

5. The method according to claim 4, wherein the at least two glyph attributes of the plurality of glyphs are selected from the group consisting of: glyph shape; glyph line weight; glyph line style; glyph line color; glyph fill color; glyph fill transparency; glyph fill pattern; glyph major axis size; glyph minor axis size; glyph orientation; glyph text; glyph radius of curvature; and glyph orientation.

6. The method according to claim 1, wherein the at least two biological attributes for which measurements were made in the anatomical region are selected from the group consisting of: scar level; lateness attribute; voltage level; activation time; mechanical strain; electrogram frequency; electrogram fractionation; cycle length; fiber orientation; tissue thickness; fat content; local impedance; and electrogram power.

7. The method according to claim 1, wherein the geometry information comprises time-varying geometry information.

8. The method according to claim 7, wherein the biological information comprises time-varying biological information.

9. The method according to claim 8, wherein displaying a graphical representation of the anatomical region comprises superimposing a time-varying map of at least two biological attributes of the anatomical region upon a time-varying geometric model of the anatomical region, wherein the time-varying map of at least two biological attributes and the time-varying geometric model are synchronized time-wise.

10. A method of generating an anatomical map, comprising:
acquiring a first plurality of measurements of a first biological attribute from within an anatomical region;
acquiring a second plurality of measurements of a second biological attribute from within the anatomical region;
designating a first glyph attribute to represent the first biological attribute;
designating a second glyph attribute to represent the second biological attribute;
displaying a geometric model of the anatomical region;
superimposing a plurality of glyphs on the geometric model of the anatomical region, wherein
the first glyph attribute of each glyph of the plurality of glyphs corresponds to a measurement of the first biological attribute at a corresponding location within the anatomical region, and
the second glyph attribute of each glyph of the plurality of glyphs corresponds to a measurement of the second biological attribute at the corresponding location within the anatomical region.

11. The method according to claim 10, wherein the anatomical region comprises a portion of a heart, and wherein the geometric model of the anatomical region is created from location data collected using a cardiac mapping and visualization system.

12. The method according to claim 10, wherein the geometric model of the anatomical region is created from location data collected using at least one of an MRI system and a CT system.

13. The method according to claim 10, further comprising:
acquiring a third plurality of measurements of a third biological attribute from within the anatomical region;
designating a third glyph attribute to represent the third biological attribute; and
modifying the plurality of glyphs superimposed on the geometric model of the anatomical region such that the third glyph attribute of each glyph of the plurality of glyphs corresponds to a measurement of the third biological attribute at the corresponding location within the anatomical region.

14. The method according to claim 10, further comprising storing a data file comprising the first plurality of measurements of the first biological attribute and the second plurality of measurements of the second biological attribute.

15. The method according to claim 14, wherein the data file stores the first plurality of measurements of the first biological attribute and the second plurality of measurements of the second biological attribute according to locations within the anatomical region at which they were measured.

16. The method according to claim 14, wherein the data file comprises a file format capable of storing multivariate biological data associated with geometric information in an XML format.

17. A system for generating an anatomical map, comprising:
a geometry information processor that acquires geometry information pertaining to an anatomical region, the geometry information comprising position information for a plurality of points in the anatomical region;
a biological information processor that acquires biological information pertaining to the anatomical region, the biological information comprising a plurality of biological attribute measurements made in the anatomical region;
a mapping processor that associates the geometry information with the biological information and that displays a graphical representation of the anatomical region, the graphical representation including a map of at least two biological attributes for which measurements were made in the anatomical region superimposed upon a geometric model of the anatomical region.

18. The system according to claim 17, further comprising an interface processor that establishes a graphical user interface, wherein the graphical user interface includes user controls to establish a glyph convention, wherein a glyph is defined by a plurality of glyph attributes, and wherein each glyph attribute is associated with a biological attribute.

19. The system according to claim 18, wherein the user controls comprise a drag and drop interface.

20. The system according to claim 17, further comprising a storage medium, and wherein the storage medium stores a data file comprising a plurality of records, wherein each record includes the associated biological information and geometry information of the mapping processor.
